(19) United States
(12) Patent Application Publication
(10) Pub. No.: US 2003/0103777 A1
(43) Pub. Date: Jun. 5, 2003

(54) Printer, printer system, and print job processing method and program

(75) Inventors: Yoshinobu Nakamura, Kawasaki (JP); Hirotomo Terada, Kawasaki (JP)

Correspondence Address: ARMSTRONG,WESTERMAN & HATTORI, LLP, 1725 K STREET, NW, SUITE 1000, WASHINGTON, DC, 20006, US

(73) Assignee: Fujitsu Limited, Kawasaki (JP)

(21) Appl. No.: 10/115,207

(22) Filed: Apr. 4, 2002

(30) Foreign Application Priority Data
Nov. 30, 2001 (JP) 2001-367047

(51) Int. Cl. G03G 15/00

(52) U.S. Cl. 399/82

(57) ABSTRACT

If there is competition among printing jobs received by a printer, the most suitable priority ranking is determined. A printer includes a storage unit for storing job data converted to bitmap data and a control unit for implementing storage processing for converting a received print job to bitmap data and storing this data in the storage unit in job units, and print processing for reading out the stored bitmap data and executing printing operations in page units. The control unit compares the numbers of print pages for a plurality of jobs for which bitmap data has been stored, determines priority rankings for the jobs that are to be printed.

### BACKGROUND OF THE INVENTION

1. Field of the Invention

The present invention relates to a printer, a printer system, and a print job processing method and program for same for printing in a network environment, and more particularly, to a printer, printer system, and print job processing method and program whereby printing is performed by assigning priority rankings when there is competition between a plurality of print jobs.

2. Description of the Related Art

A printer receives print jobs, emulates and converts them to a bitmap, and then the printer performs printing on a print medium. In a normal printer, the received print jobs are processed in sequence in this series of printing processes (priority rankings being assigned in the order in which jobs are received).

Therefore, if there is competition between print requests, and if a job with a large number of pages to be printed is included among these jobs, then other jobs will not be processed during printing of the job comprising the large number of pages, and none of the users which make a print request thereafter will be able to implement print processing until printing of this job is completed.

Consequently, if there is competition in printing, then the overall print waiting time is increased. That is, if the job waiting time for each individual job is taken as “time waiting for completion of other print jobs”+“print processing time”, then the “overall print waiting time” is defined as the print waiting time for all the jobs as calculated by “job waiting time×number of competing jobs”.

As means for shortening this overall print waiting time, methods are known for controlling the priority rankings assigned to the print jobs. In the prior art, the following priority ranking assignment method has been proposed.

FIG. 14 is an illustrative diagram of a first prior art method. As illustrated in FIG. 14, a print server 106 is provided in a system wherein a plurality of client PCs (personal computers) 104 and a printer 102 are connected via a network 100 (LAN, or the like). The print server 106 controls the priority of the print jobs sent to the printer 102 by the respective PCs (for example, Japanese Patent Laid-open No.2000-353060).

In this method, it is possible to assign priority rankings to print jobs passing via a print server having a priority ranking assignment function. The priority ranking assignment method involves estimating the printing time required for a print job, and then assigning priority rankings in order of the estimated printing time in such a manner that jobs requiring little printing time are given priority in printing.

For example, a method has been disclosed whereby the estimated printing time is calculated by estimating the time from reception of a print command to completion of bitmap conversion according to the print contents (text, figures, etc.)

Moreover, as shown in FIG. 15, a second prior art method is proposed (for example, in Japanese Patent Laid-open Hei No.5-162415 or the like), wherein the printer device has a threshold value for a number of print pages (for example, 100 pages) in order to determine the priority rankings for print jobs, and if a job exceeds this value, then the priority ranking thereof is lowered, and other jobs are interposed inside that job.

In the first prior art method illustrated in FIG. 14, it is possible to assign priority rankings only to print jobs passing via the print server. However, with the increasing complexity of network systems in recent years, it has been desired to process print requests from a variety of print environments on a single printer. Therefore, if a server or client making print requests that bypass the print server is connected to the network, it is difficult to assign priority rankings which also cover print requests made by a server or client of this kind.

In other words, since priority rankings are only assigned to print requests that pass via the network print server, it is difficult to adapt the method to various types of network systems.

Moreover, in the first prior art method, the estimated printing time is calculated and priority rankings are assigned in order, starting from jobs having shorter estimated printing times. In order to calculate these estimated printing times, after analysis of the transmitted print data, a predicted time is calculated according to the type of data, the predicted bitmap conversion time, and the number of print pages.

However, as illustrated in FIG. 16, in a network system, the time taken to carry out a print job is represented by the sum of the processing time T1 of the print server 106, the transfer time T2 for transferring the print job data from the print server 106 via the network 100 to the printer 102, the conversion processing time T3 for converting the transferred print job to a bitmap inside the printer 102, and the printing operation time T4 taken by the printer 102 after conversion to bitmap data.

The printing operation time T4 is determined by the operating capability of the printer engine, and it is a uniform value, such as 20 pages per minute, for example; the processing time T1 is also virtually uniform. On the other hand, the transfer time T2 and the conversion time T3 differ with the print contents. Namely, they will differ by a time width of ΔT1 in the transfer time T2 and a time width of ΔT2 in the bitmap conversion time T3, depending on whether the printing data is text (characters and figures) or a bitmap (image), or the like.

Consequently, even for print jobs comprising the same number of pages, in the case of a text data print job ‘Amin’, the transfer time and conversion time will have short values of (T2−ΔT1), (T3−ΔT2) respectively, whereas in the case of a bitmap data print job ‘Amax’, the transfer time and conversion time will have long values of T2 and T3 respectively. Moreover, the transfer time T2 depends greatly on the load on the LAN (Local Area network), or other type of network.

Therefore, in a method where the estimated print time is predicted by analysis of the print data, as in the first prior art method, in many cases, there is a discrepancy between the estimated print time and the actual print time. Therefore, the print job having the shortest printing time cannot be determined accurately and it becomes difficult to achieve optimum assignment of priority rankings.

Furthermore, in order to improve the accuracy of estimated printing times, it is necessary to perform even more detailed print data analysis and to estimate transfer times. Therefore, the processing time of the server is increased, the process of assigning priority ranking takes time, and it becomes difficult to achieve real-time processing of a multiplicity of print jobs.

In the second prior art method, as illustrated in FIG. 15, in a printer device set to a threshold value of 100 pages, for example, it is assumed that the printer receives a 200 page print job (B) whilst it is printing a 101 page print job (A). In the printer, when 100 pages of print job A have been printed, this print job (A) will be determined to be a print job with a large number of pages and the priority ranking thereof will be lowered, whereupon print job (B) will be interposed and printed. Therefore, although job (A) would be completed after the printing of one more page thereof, it is necessary to wait until 100 pages of print job (B) have been completed, and hence it becomes difficult to reduce print waiting time.

### SUMMARY OF THE INVENTION

Accordingly, it is an object of the present invention to provide a printer, printer system, printer job processing method and program thereof for minimizing the overall print waiting time when there is competition between print requests in a network environment.

It is a further object of the present invention to provide a printer, printer system, printer job processing method and program thereof for determining the most suitable priority rankings for a plurality of print requests and for executing print processing in a network environment, without recourse to the source of the request.

It is yet a further object of the present invention to provide a printer, printer system, printer job processing method and program thereof for determining the most suitable priority rankings for a plurality of print requests, and for executing print processing, by using a function for receiving and rendering print data and storing printing data in a memory device, in an asynchronous and parallel fashion with respect to print processing.

In order to achieve the aforementioned objects, the job processing method for a printer according to the present invention is a job processing method for a printer which receives print jobs and performs printing operations corresponding to the print jobs, comprising: a storing step for developing the received print jobs to bitmap data and storing the bitmap data with job units in a storage device; and a print processing step for reading out the stored bitmap data and performing print operations in page units; the print processing step consisting of: a step for comparing the number of print pages of a plurality of jobs for which the bitmap data has been stored, and determining priority rankings for the jobs that are to be printed; and a step for reading out the bitmap data of a job selected by the determination of the priority rankings, and performing print operations in page units.

The printer according to the present invention is a printer for receiving print jobs and performing printing operations corresponding to the print jobs, comprising: a storage unit for storing job data developed to bitmap data; and a control unit for implementing storage processing for developing the received print jobs to bitmap data and storing the bitmap data with job units in the storage unit, and print processing for reading out the stored bitmap data and executing printing operations in page units; wherein the control unit compares the number of print pages for a plurality of jobs for which the bitmap data has been stored, determines priority rankings for the jobs that are to be printed, reads out the bitmap data of a job selected by the determination of the priority rankings, and performs print operations in page units.

The printer system according to the present invention comprises a printer for receiving print jobs and performing printing operations corresponding to the print jobs, and a plurality of clients issuing the print jobs to the printer via a network. The printer comprises a storage unit for storing job data developed to bitmap data; and a control unit for developing the received print jobs to bitmap data, storing the developed bitmap data with job units in the storage unit, reading out the stored bitmap data and executing printing operations in page units; wherein the control unit compares the number of print pages for a plurality of jobs for which the bitmap data has been stored, determines priority rankings for the jobs that are to be printed, reads out the bitmap data of a job selected by the determination of the priority rankings, and performs print operations in page units.

The program according to the present invention is a program for receiving print jobs and causing a printer to execute printing operations corresponding to the print jobs, containing program data for performing a storing step of developing the received print jobs to bitmap data and storing the bitmap data with units of jobs in the storage device, and program data for comparing the number of print pages of a plurality of jobs for which the bitmap data has been stored, determining the priority rankings of the jobs that are to be printed, reading out the bitmap data for a job selected by the determination of priority rankings, and executing printing operations in page units.

In the present invention, printing competition is determined at the printer, and priority rankings are determined after bitmap developing, for job data that has been developed to bitmap data. Therefore, it is possible to determine priority rankings for a printing operation time defined by the number of print pages, and hence accurate priority rankings which enable shortening of the overall print waiting time can be determined. Moreover, since the printer executes job data storage processing and print processing in parallel, it is possible to determine these priority rankings in a simple manner.

Furthermore, in the present invention, it is desirable that the print processing step further comprises a step for executing determination of the priority rankings when it is detected that the number of printed pages for one job has reached a prescribed number of pages during the printing operation. Thereby, it is possible to interpose a new job having a small number of pages during execution of another print job, and hence the overall print waiting time can be shortened further.

Moreover, in the present invention, it is desirable that the storing step is executed in units of received jobs, and the step for determining priority rankings is executed when the bitmap data for the plurality of jobs has been stored in the storage device. Thereby, it is possible to eliminate unnecessary determination of priority rankings, and printer efficiency can be improved.

Furthermore, in the present invention, it is desirable that the print processing step further comprises a step for performing the printing operation each time bitmap data for one page is stored, when the bitmap data for a plurality of jobs is not stored in the storage device. Thereby, it is possible to prevent reduction of the print processing speed when there is only one job.

Moreover, in the present invention, it is desirable to further comprise a step of updating a number of jobs each time a job is received, and a step of determining whether or not to implement the priority ranking determination step by referring to the number of jobs. Thereby, it is possible to determine readily whether or not data for a plurality of jobs is present in the storage device, and execution of the process for determining priority rankings can be controlled readily.

Furthermore, in the present invention, it is desirable to also comprises a step for controlling execution of the priority ranking determining step by referring to a flag indicating whether or not to execute the priority ranking determining step each time the prescribed number of pages has been printed consecutively. Thereby, it is possible to set up priority ranking determination on whether or not to interpose another job during consecutive printing, and thus operation of the printer can be adapted to the environment in which it is used.

### BRIEF DESCRIPTION OF THE DRAWINGS

FIG. 1 is an external view of one embodiment of a printer according to the present invention;

FIG. 2 is a compositional view of a printer system using the printer shown in FIG. 1;

FIG. 3 is an internal block diagram of the printer shown in FIG. 1;

FIG. 4 is a functional block diagram of firmware in the controller shown in FIG. 3;

FIG. 5 is a compositional diagram of a management table according to a first embodiment of the present invention;

FIG. 6 is a flow diagram of job data storage processing in a first embodiment of the present invention;

FIG. 7 is a flow diagram of print processing according to a first embodiment of the present invention (part 1);

FIG. 8 is a flow diagram of print processing according to a first embodiment of the present invention (part 2);

FIGS. 9A, 9B, 9C, 9D and 9E are illustrative diagrams of the priority ranking determination processing in FIG. 7 and FIG. 8;

FIG. 10 is a compositional diagram of a management table according to a second embodiment of the present invention;

FIG. 11 is a print processing flow diagram according to a second embodiment of the present invention (part 1);

FIG. 12 is a print processing flow diagram according to a second embodiment of the present invention (part 2);

FIG. 13 is an illustrative diagram of the priority ranking determination processing in FIG. 11 and FIG. 12;

FIG. 14 is an illustrative diagram of a first prior art method;

FIG. 15 is an illustrative diagram of a second prior art method; and

FIG. 16 is an illustrative diagram of problems relating to the method for determining priority rankings according to the prior art.

### DESCRIPTION OF THE PREFERRED EMBODIMENTS

Below, embodiments of the present invention are described with reference to the drawings, in the following order: print system, job data storage processing, first print processing, second print processing, and further embodiments.

### Print System

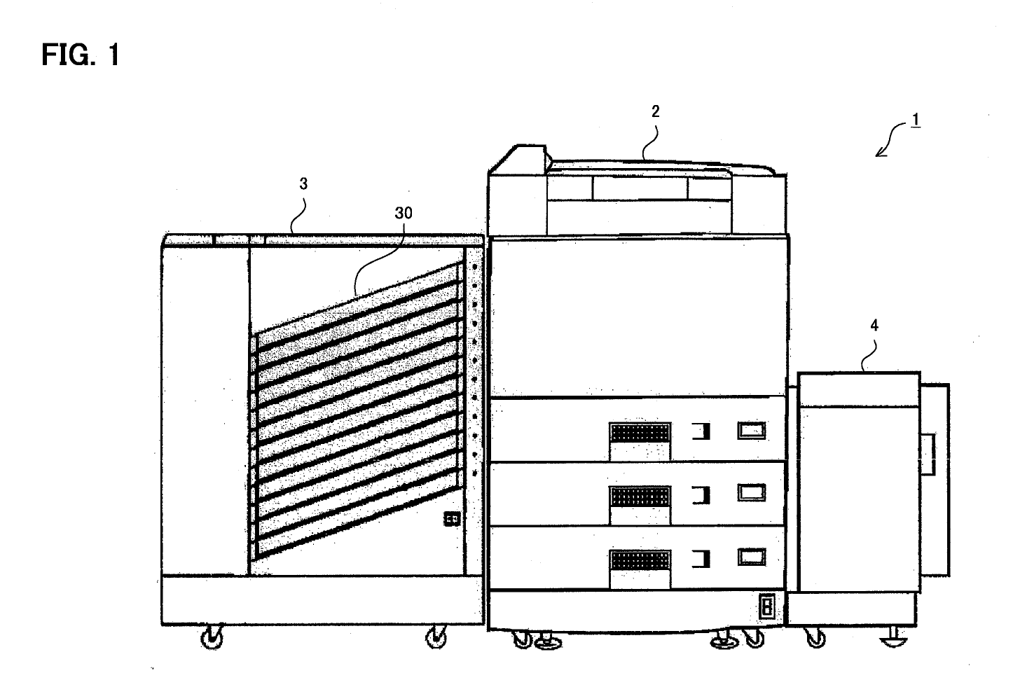

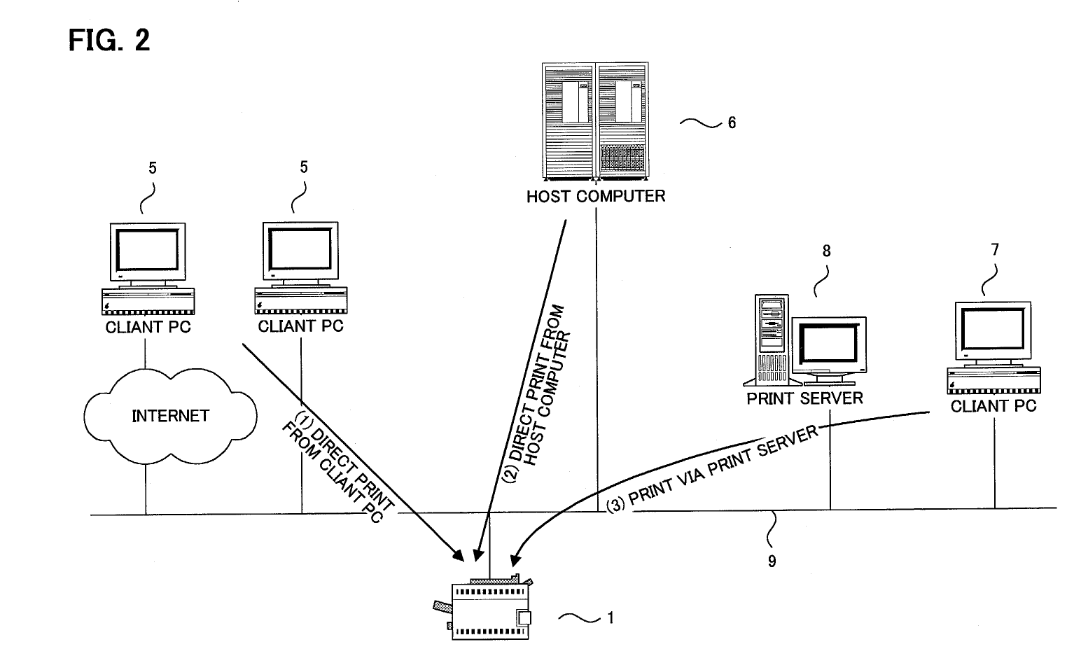

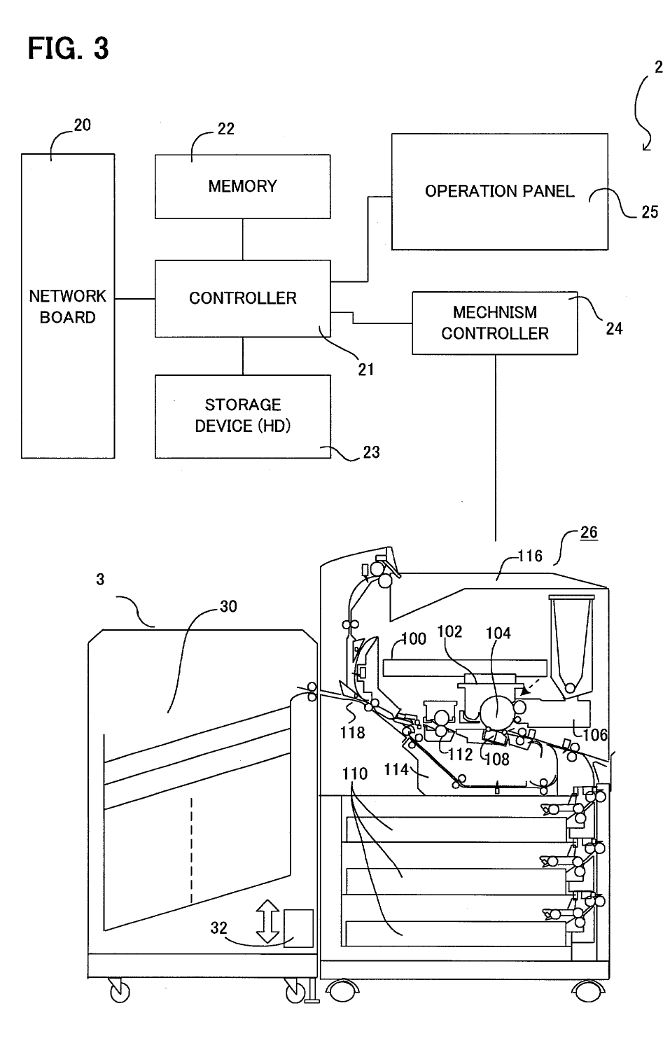

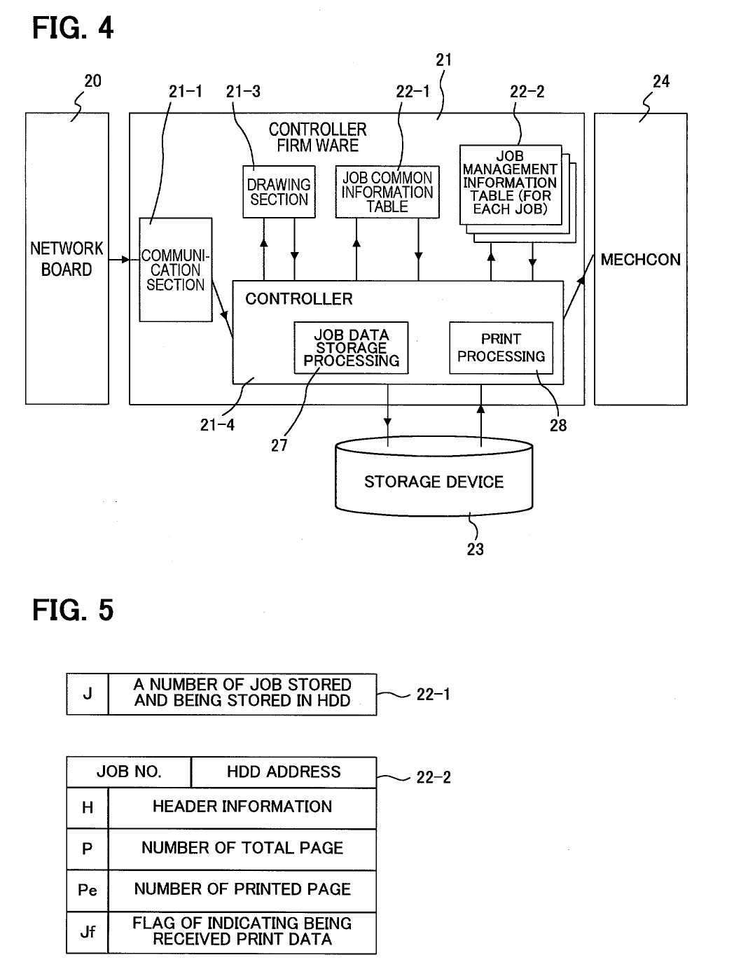

FIG. 1 is an external view of one embodiment of a printer according to the present invention; FIG. 2 is a compositional view of a printer system using the printer illustrated in FIG. 1; FIG. 3 is a block diagram of the printer in FIG. 1; FIG. 4 is a block diagram of the firmware of the controller illustrated in FIG. 3; and FIG. 5 is an illustrative diagram of the contents of the table illustrated in FIG. 4.

As shown in FIG. 1, the printer 1 comprises a printer device 2, and optional devices 3 and 4. The optional device 3 consists of a multi-bin stacker having a storage shelf 30 for each job, and the optional device 4 consists of a high-capacity hopper for accommodating a large volume of cut printing medium. The optional device 3 is provided according to requirements.

The printer device 2 is constituted by a cut sheet laser printer having a high-capacity storage device, and forms toner images on paper sheets supplied to the device by a commonly known electro-photographic method, and the printed paper then being ejected to a stacker. This printer device 2 is capable of high-speed printing of the order of 40 pages per minute, and has a multi-session function which enables it to process print data from different systems simultaneously.

As shown in FIG. 2, this printer 1 is connected via a network 9, such as a LAN (Local Area Network) or WAN (World Area Network), to a client PC (Personal Computer) 5, host computer 6, client PC 7 and print server 8.

As shown in FIG. 2, the printer 1 receives print requests classified into three types, namely, (1) direct print requests from the client PC 5, (2) direct print requests from the host computer 6, and (3) print requests received via the print server, and it performs print processing accordingly. As described hereinafter, if there is competition between print requests of types (1) to (3), the printer 1 does not process the received plurality of jobs in sequential fashion, but rather, compares the total number of print pages of the respective jobs, and then assigns priority ranking for the jobs to be printed on the basis of this comparison, so as to minimize the overall print waiting time.

As shown by the block diagram of the printer device (hereinafter, called the “printer”) 2 in FIG. 3, the printer 2 is constituted by a network board (network section) 20, memory 22, controller 21, high-capacity storage device 23, mechanical controller 24, operating panel 25 and print engine 26.

The network board 20 is connected to the network 9 and receives print job (data) sent by the computer (5, 6, 8 in FIG. 2) issuing print request.

The controller 21 performs job data storage processing for emulating the print jobs received from the network board 20, developing them to bitmap data, and storing the developed bitmap data (hereinafter, called “job data”) and print processing for transferring the bit map (job) data to the mechanical controller 24 and requesting printing. The memory 22 stores a table, and the like, required for processing the control firmware which runs on the controller 21.

The high-capacity storage device 23 comprises, for example, a large-capacity storage device of approximately 15 Gigabyte, for which a hard disk drive (HD) is suitable. This high-capacity storage device 23 stores bitmap data developed by the controller 21 and is able to store bitmap data corresponding to several tens of thousands of pages.

The mechanical controller 24 controls the print engine 26 and the multi-bin stacker 3, and controls the printing operation, in accordance with print instructions from the controller 21. The operating panel 25 is, for example, constituted by a liquid-crystal panel, on which various settings and statuses are displayed.

The print engine 26 is constituted by a cut page printer mechanism based on an electro-photographic method. In other words, a three-stage paper cassette 110 is disposed in the lower of the print engine, an electro-photographic mechanism in the central level thereof, and an overhead stacker 116 in the upper level thereof.

In the electro-photographic mechanism, a charging/cleaning unit 102 charges uniformly a photosensitive drum 104, and then a laser scanner 100 exposes an image thereon. A developing unit 106 develops the electrostatic latent image on the photosensitive drum 104 generated by the image exposure with a developer to form a toner image on the photosensitive drum 104. A transfer device 108 transfers the toner image on the photosensitive drum 104 to a paper sheet transported thereto, and a fixing device 112 fixes the toner image on the paper sheet.

A path-switching lever 118 switches the eject destination of the fixed paper sheet between the overhead stacker 116 and the multi-bin stacker 3. Moreover, since the printer engine 26 is capable of double-sided printing, a front/rear reversal path 114 is also provided. When performing double-sided printing, a paper sheet bearing a fixed toner image on the front surface thereof is conveyed in the direction of the overhead stacker 116 by means of the switching lever 118, whereupon the paper sheet is conveyed back to the front/rear reversal path 114 and then conveyed via the front/rear reversal path 114 to the introduction inlet to the photosensitive drum 104. By conveying this paper sheet along a path whereby it passes the photosensitive drum 104, the toner image on the photosensitive drum 104 is transferred and fixed onto the rear face of the paper sheet.

The multi-bin stacker 3 comprises multiple-level storage shelves 30, and a driving mechanism for driving same upwards and downwards. Upon commands from the mechanical controller 24, the storage shelf 30 corresponding to the job is positioned at the eject opening of the print engine 26, and the ejected paper sheets are accommodated in this storage shelf 30.

The controller 21 comprises a processor which executes the controller firmware (firmware program). FIG. 4 is a functional block diagram showing a block view of the firmware in the controller 21. The respective functions of the controller firmware are as follows.

The communications section 21-1 divides the received data into a header section and print data section, and transfers it to a control section 21-4. The drawing section 21-3 converts the print data to bitmap data. The control section 21-4 controls all of the processing from the reception of print data to the establishment of priority rankings for print jobs and the transmission of bitmap data to the mechanical controller 24.

A common job information table 22-1 is provided in the memory 22 and stores common information used for managing the jobs. As illustrated in FIG. 5, the common job information table 22-1 contains the number of jobs ‘J’ being stored, or currently under storage, in the high-capacity storage device 23.

A job management information table 22-2 is set in the memory 22 for each job, and it manages the individual information for each job. As shown in FIG. 5, the job management information table 22-2 created for each job contains the job number, an address in the high-capacity storage device 23 where the bitmap is stored, the header section information ‘H’ separated by the communications section (information such as paper size, double/single-side printing, and the like), the total number of print pages ‘P’ in the job, the number of pages ‘Pe’ already printed in the job, and an identification flag for print data reception ‘Jf’ (ON when receiving data, OFF when data reception completed).

The control section 21-4 plays a central role in the controller firmware, and it implements priority ranking assignment for printing jobs by acting in conjunction with the functions described above. More specifically, as described hereinafter, the control section 21-4 implements storage processing 27 for the received job data and print processing 28 asynchronously in a parallel fashion. One of the characteristic features of the present invention is that the priority ranking assignment is performed during print processing 28, in other words, the priority rankings are decided after bitmap conversion.

### Storage Processing for Received Print Data

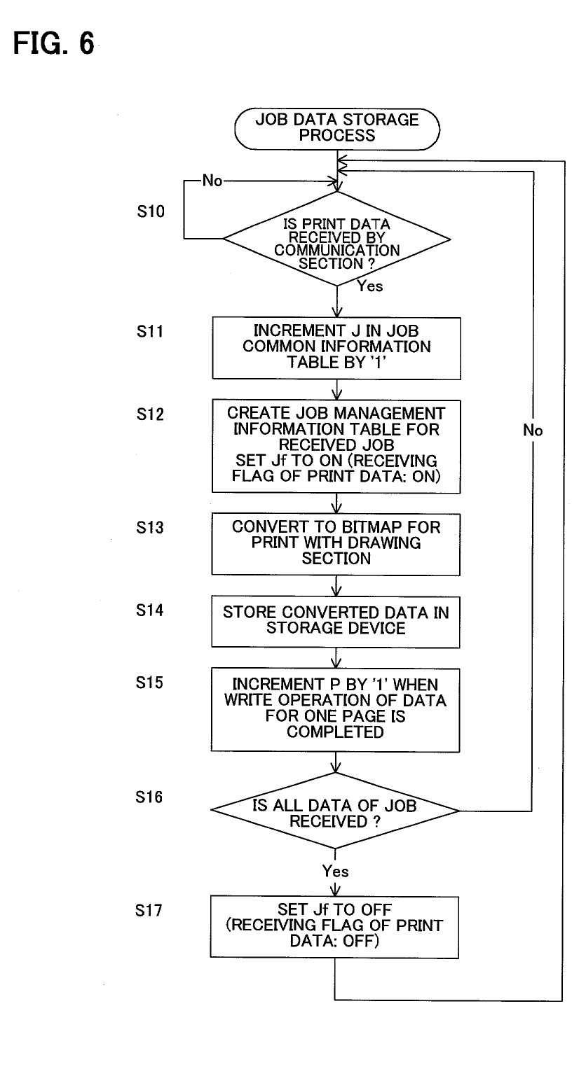

Next, the storage processing for developing the received print data to a bitmap and storing this data in the high-capacity storage device 23 is described with reference to the processing flow diagram of job data storage processing 27 performed by the controller firmware of the printer, as illustrated in FIG. 6.

(S10) Firstly, the communications section 21-1 determines whether a print job has been received from the network board 20. When print job data is received, then the communications section 21-1 separates this print job data into the header section and the print data and sends the separated data as job data to the control section 21-4.

(S11) Upon receiving new job data from the communications section 21-1, the control section 21-4 increments the number of jobs ‘J’ in the common job information table 22-1 by ‘1’.

(S12) Next, the control section 21-4 creates a job management information table 22-2 for that job and sets the reception flag ‘Jf’ to ON. The reception flag ‘Jf’ is used to prevent incorrect assignment of priority rankings during print processing, as described hereinafter. The header section information (paper size, single/double-side printing instructions, and the like) in the received job data is written to the header section information H of the job management information table 22-2 and is used to control printing.

(S13) The control section 21-4 also requests development of the print data into bitmap data, to the drawing section 21-3. The drawing section 21-3 draws the print data to a bitmap.

(S14) The control section 21-4 stores the developed data (job data) in the high-capacity storage device 23.

(S15) In storage processing to the high-capacity storage device 23, when data storage for one page has been completed, the control section 21-4 increments the total number of pages ‘P’ in the job management information table 22-2 by ‘1’. When storage of all the job data has been completed, ‘P’ will have the same value as the total number of pages to be printed.

(S16) The control section 21-4 determines whether storage processing for all job data has been completed, and if storage processing for all job data has not yet been completed, then it returns to step S10.

(S17) The control section 21-4 repeats the aforementioned processing until the end of the job data, and when reception of the job data is completed, switches the reception flag ‘Jf’ in the job management information table 22-2 to OFF.

In this way, by storing print job data in the high-capacity storage device 23 in a state where it has been developed to bitmap data, it is possible to achieve accurate assignment of priority rankings, as described below. Thereafter, the aforementioned processing is repeated as and when a print job is received, regardless of the print processing.

### First Print Processing

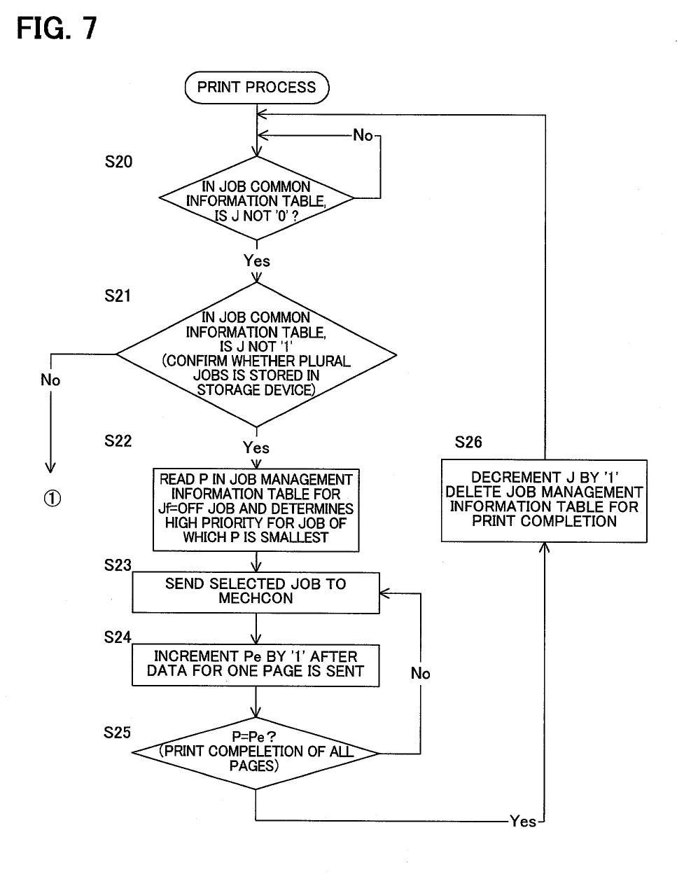

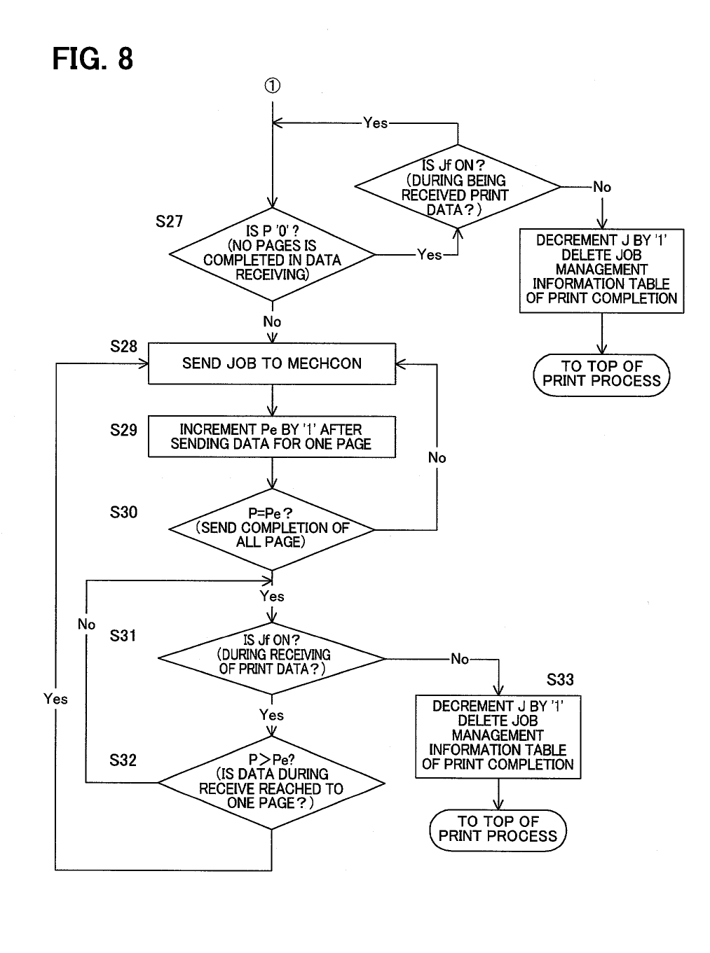

Next, a first embodiment of print processing according to the present invention is described. FIG. 7 and FIG. 8 are processing flow diagrams for print processing by assignment of priority rankings to bitmap data stored in the high-capacity storage device.

(S20) The control section 21-4 periodically monitors the common job information table 22-1 and determines whether the number of jobs ‘J’ is any value other than ‘0’ due to reception of job data.

(S21) The control section 21-4 starts print processing when the number of jobs ‘J’ is greater than ‘0’, in other words, when the number of jobs ‘J’ has been changed to ‘1’ or more. The control section 21-4 also determines whether the number of jobs ‘J’ is J=1 or whether J>1, and it changes the processing method according to this result. More specifically, processing is differentiated according to whether or not there already exists bitmap data for another job in the high-capacity storage device 23 when job data is received. The merits of differentiating processing in this way are described hereinafter.

(S22) When the number of jobs ‘J’ is J>1, then the control section 21-4 judges that there is a plurality of job data present in the high-capacity storage device 23 and it implements priority ranking assignment for the print jobs. This priority ranking assignment function during print processing is the processing focused upon here.

In other words, priority rankings are assigned to the plurality of jobs stored in the high-capacity storage device 23. Since there exist job management information tables 22-2 which correspond in number to the value of the number of jobs J in the common job information table 22-1, the control section 21-4 compares the total number of pages ‘P’ in the existing job management information tables 22-2 (this being restricted to tables having a reception flag ‘Jf’ set to OFF), and it assigns a highest priority ranking to the smallest job. As described above, any job that are in the process of being received (a job having ‘Jf’ set to ON) is excluded from this comparison of the total number of pages ‘P’.

(S23) The job data for the selected job is read out, page by page, from the high-capacity storage device 23, and sent to the mechanical controller 24, together with its job number and header information.

(S24) Each time that the data for one page has been transmitted completely, the control section 21-4 increments by ‘1’ the number of pages printed ‘Pe’ in the job management information table 22-2 corresponding to that job.

(S25) The control section 21-4 then determines whether the number of pages printed ‘Pe’ in the job management information table 22-2 has reached the total number of pages ‘P’. When the number of pages printed ‘Pe’ has not yet reached the total number of pages ‘P’, then it returns to step S23.

(S26) On the other hand, if P=Pe, in other words, if all of the data for the job has been printed, then the number of jobs ‘J’ in the common job information table 22-1 is decremented by ‘1’ and the job management information table 22-2 corresponding to the completed job is deleted. Thereupon, the control section 21-4 returns to step S20.

(S27) When the number of jobs J is J=1 at step S21, then job data for a plurality of jobs is not present in the high-capacity storage device 23. Therefore, the job data for one page is stored in the high-capacity storage device 23, and when the total number of pages ‘P’ in the job management information table 22-2 becomes greater than ‘0’, print processing is started.

In other words, the control section 21-4 determines whether or not the total number of pages ‘P’ is ‘0’, and when the total number of pages P is ‘0’, then it investigates whether the print data reception flag ‘Jf’ in the job management information table 22-2 is ON. When the flag ‘Jf’ is ON, then this indicates that data is being received, and hence the control section 21-4 waits until the total number of pages ‘P’ changes to ‘1’ (until bitmap data for one page has been stored in the storage device 23). Conversely, when the flag ‘Jf’ is OFF, then this indicates that data is not being received, and hence the number of jobs ‘J’ in the common job information table 22-1 is decremented by ‘1’, and the job management information table 22-2 corresponding to the job is deleted. Thereupon, it returns to step S20.

(S28) When the total number of pages ‘P’ in the job management information table 22-2 is not ‘0’, then the job data (bitmap data) for one page stored in the high-capacity storage device 23 is read out and sent to the mechanical controller 24.

(S29) When transmission of the data for one page has been completed, the number of pages printed ‘Pe’ in the job management information table 22-2 is incremented by ‘1’.

(S30) The control section 21-4 then judges whether the number of pages printed ‘Pe’ in the job management information table 22-2 has reached the total number of pages ‘P’. When the number of pages printed ‘Pe’ has not reached the total number of pages ‘P’, then it returns to step S28.

(S31) On the other hand, when P=Pe, in other words, when all of the stored data for the job has been printed, then it is determined whether or not the data reception flag ‘Jf’, in the job management information table 22-2 is set to ON.

(S32) If the data reception flag ‘Jf’ is ON, then data is being received and the control section 21-4 waits until job data has been stored in the high-capacity storage device 23. More specifically, the control section 21-4 judges whether or not the total number of pages ‘P’ in the job management information table 22-2 exceeds the number of pages printed ‘Pe’, and when the total number of pages ‘P’ does not exceed the number of pages printed ‘Pe’, then it determines that the data being received (in other words, the data being developed) has not yet reached the amount of data for one page, and it returns to step S31. When, on the other hand, the total number of pages ‘P’ has exceeded the number of pages printed ‘Pe’, then the data being received has reached the amount of data for one page, and returns to step S28.

(S33) If the data reception flag Jf is not ON at step S31, then no data is being received, and hence that job is judged to be completed and the number of jobs ‘J’ in the common job information table 22-1 is decremented by ‘1’, and the job management information table 22-2 corresponding to the completed job is deleted. Thereupon, the control section 21-4 returns to step S20.

In this way, according to the present invention, the printer device performs storage processing for received print data, and print processing, in a parallel and asynchronous fashion. Therefore, when a plurality of jobs are received, (if J>1), then efficient print processing can be achieved whereby print processing is performed starting from a job for which bitmap development is completed, while a job being received is restricted to bitmap development only.

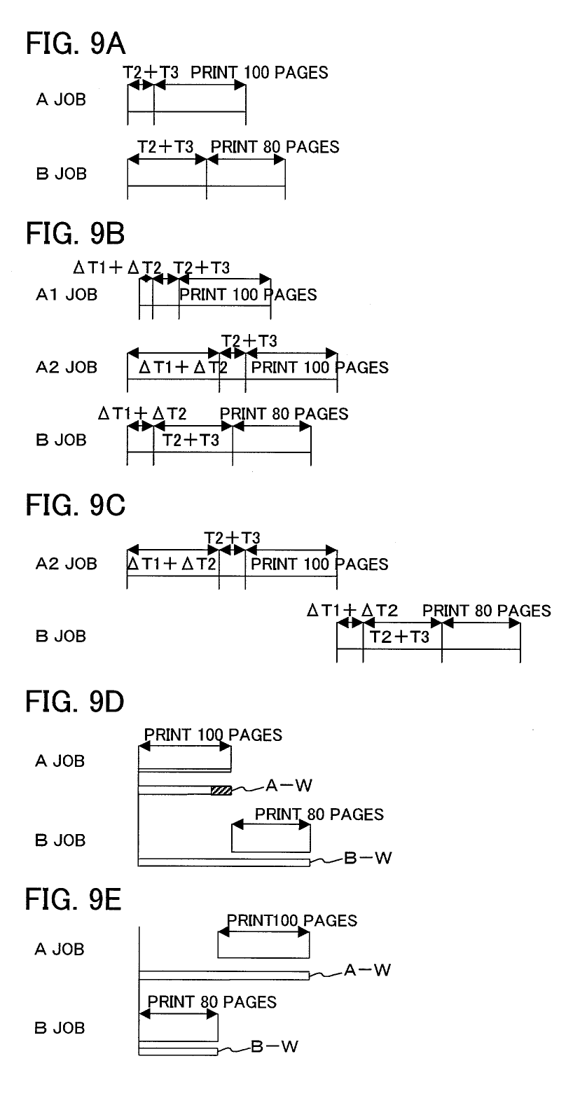

Here, a case where there is competition between a 100-page print job A and an 80-page print job B, as shown in FIG. 9A, is considered as an example. In the first prior art method, in order to determine priority rankings amongst a plurality of jobs spooled in a print server, the estimated printing times for the 100-page print job A and the 80-page print job B are calculated, including the job transfer time T2 and the conversion time T3, and the priority rankings for the plurality of jobs are decided by comparing these estimated printing times.

If, as in the example in FIG. 9A, print job A is predicted to have a shorter estimated print time than print job B and priority rankings are determined before bitmap development, then print processing will be implemented by giving priority to print job A which has a slightly shorter total required printing time, and as shown in FIG. 9C, the transfer/development processing and print execution processing for print job A2 (100 pages) will be performed before the transfer/development processing and print execution processing for print job B (80 pages).

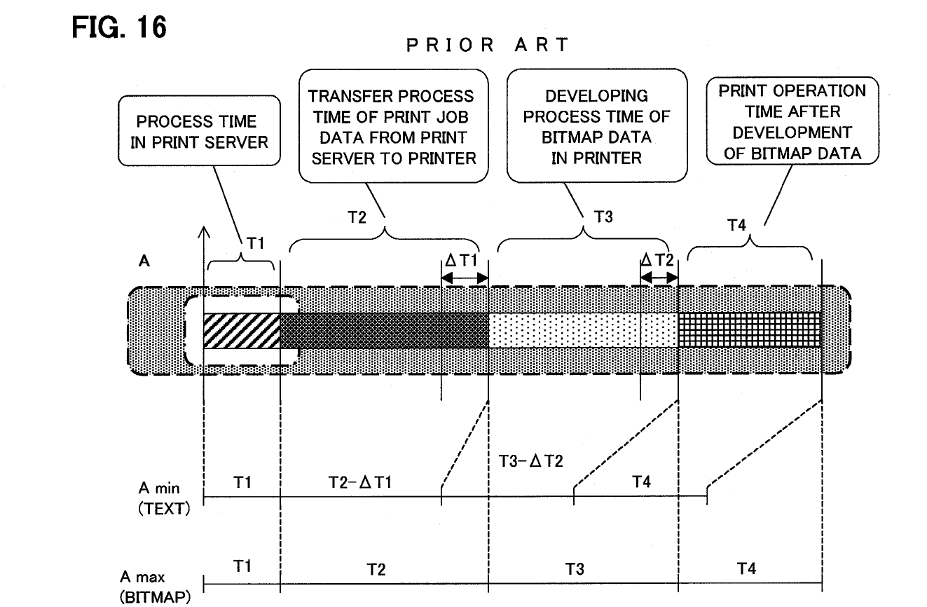

However, in actual print processing, as illustrated in FIG. 9B and described in FIG. 16, due to the inclusion of factors ΔT1 and ΔT2, there will be cases where the actual print processing time for print job A will show little error with respect to the estimated print time (job A1) and cases where it will show significant error with respect to the estimated print time (job A2).

Therefore, cases may arise where, conversely to the prediction made in the print server, the actual print processing time for print job A is longer than the actual print processing time for print job B (as in job A2), and if print job A2 is given priority as in FIG. 9C, this will have the opposite effect of lengthening the overall print waiting time.

In other words, since the priority rankings are determined at the print server, the estimated printing times cannot be predicted simply by comparing the number of pages to be printed, and hence it is necessary to introduce the indefinite factors of transfer and conversion time.

In the present invention, where the developed bitmap data is spooled in the printer, it is possible to determine priority rankings for a plurality of jobs spooled in the printer. In the present case, if a conventional priority ranking assignment method implemented in the print server is adopted and the indefinite factors of transfer and development time are taken into consideration, then printing will be performed in the order of printing of job A followed by printing of job B, as shown in FIG. 9D, and hence the overall print waiting time will be lengthened.

According to the present invention, since the priority rankings are determined after developing to bitmap data, it is possible to determine priority rankings according to an established printing execution time. In other words, according to the present invention, print processing for print job B (80 pages) is always implemented before print processing for print job A (100 pages), as illustrated in FIG. 9E.

As revealed by the comparison of waiting times A-W and B-W for job A and job B illustrated in FIG. 9D and FIG. 9E, respectively, the overall print waiting time in (sum of waiting time for job A and waiting time for job B) in FIG. 9E is shorter than the overall print waiting time (sum of waiting time for job A and waiting time for job B) in FIG. 9D, by the time period indicated by the shaded portion of FIG. 9D.

In other words, since priority rankings are assigned after bitmap development, it is possible to prioritise print processing for jobs having a shorter print processing time (here taken as a job having fewer pages to be printed) and hence the overall print waiting time can be shortened. In the prior art, since the transfer and development times are predicted, these predictions are not necessarily accurate, and since the priority rankings are determined before data transfer, results such as that illustrated in FIG. 9D may arise, where shortening of the overall print waiting time cannot be achieved.

Moreover, in the embodiment described above, if there is no competition between printing requests and there is no job for which bitmap development has been completed held in the high-capacity storage device 23, then processing efficiency will be degraded if print processing is not started until the whole of the received job has been converted to bitmap data. In order to prevent this, in cases where J=1, printing is performed starting from page data which has completed bitmap development. Due to the above, processing is differentiated between cases where J>1 and cases where J=1.

### Second Print Processing

According to a second embodiment of print processing according to the present invention, in the printer device of the first embodiment, the priority ranking of a job being print processed is revised each time a number of pages corresponding to a predetermined value have been printed. Thereby, the printing priority ranking is changed dynamically in such a manner that the printing priority ranking is increased for a job having few pages remaining to print, and hence the overall print waiting time can be minimized.

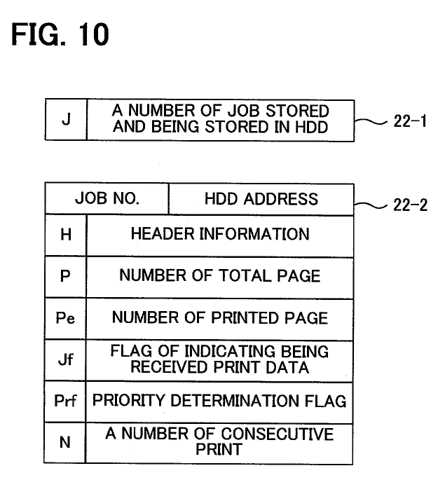

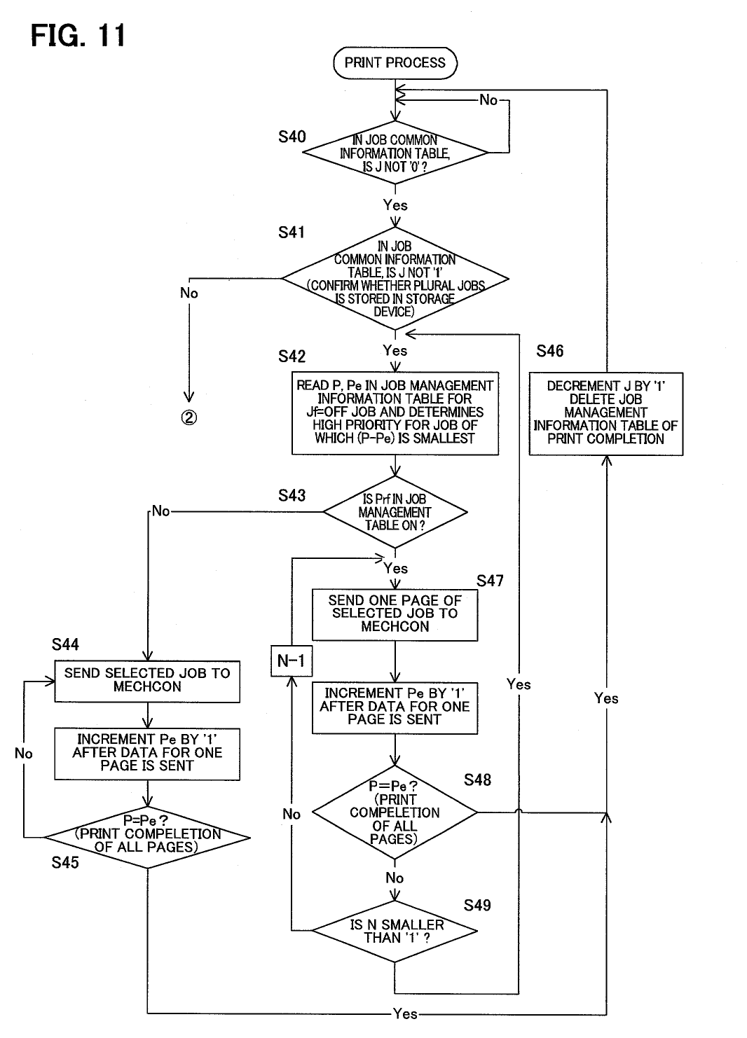

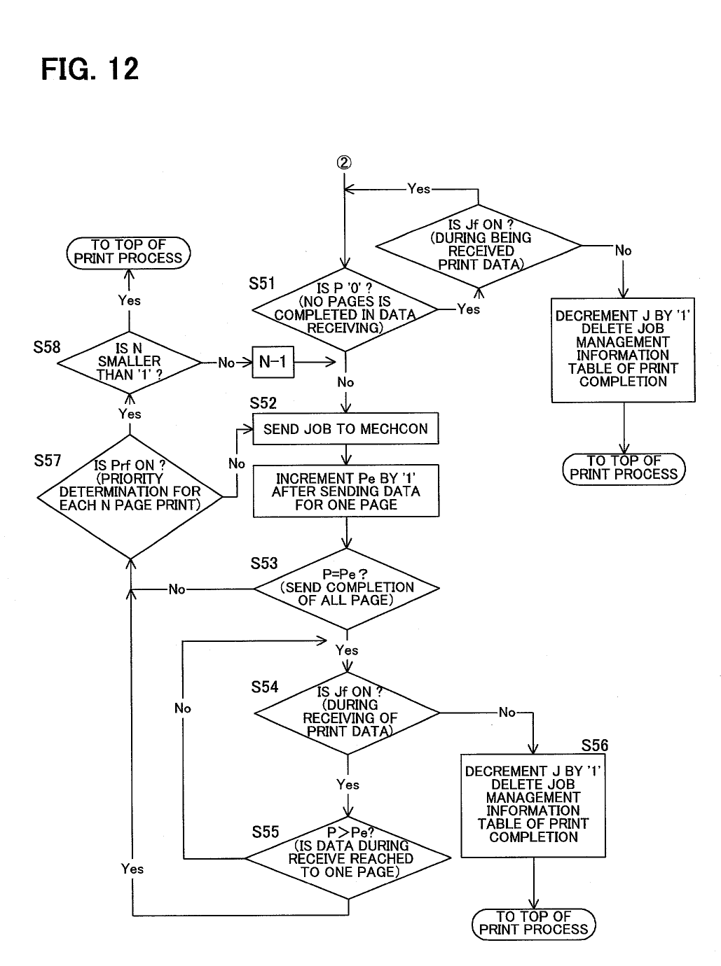

FIG. 10 is a compositional diagram of a table structure for the second embodiment of the present invention, and FIG. 11 and FIG. 12 are print processing flow diagram according to this second embodiment of the present invention.

As shown in FIG. 10, a common job information table 22-1 is provided in the memory 22, for holding common information used in managing the jobs. Similarly to FIG. 5, this common job information table 22-1 stores the number of jobs ‘J’ being stored and already under storage in the high-capacity storage device 23.

A job management information table 22-2 is set up in the memory 22 for each job, in order to manage the individual information for each job. Similarly to FIG. 5, the job management information table 22-2 created for each job contains the job number, an address in the high-capacity storage device 23 where the bitmap is stored, the header section information H separated by the communications section (information such as paper size, double/single-side printing, and the like), the total number of print pages P in the job, the number of pages Pe already printed in the job, and an identification flag for print data reception Jf (ON when receiving data, OFF when data reception completed).

In this second embodiment, the job management information table 22-2 also contains an indication flag ‘Prf’ which indicates whether or not processing for determining the priority ranking of the job being print processed will be executed, each time a number of pages corresponding to a predetermined value has been printed, (ON: set to determine priority ranking at each set number of pages; OFF: set to determine priority ranking at each job), and a number of pages N to be printed consecutively, when printing the job having the highest priority ranking.

This priority ranking indication flag Pfr and the number of pages N to be printed consecutively are previously set on the printer operation panel 25, or they may be set and inserted into the header section of the print data.

Similarly to the first embodiment, this second embodiment also uses a printer having a composition as illustrated in FIG. 1 to FIG. 4. In other words, the control section 21-4 assigns priority rankings by performing “storage processing for the received job data 27” and “print processing 28” in a parallel and asynchronous fashion. Moreover, the job data storage processing 27 involves performing the processing illustrated in FIG. 6, similarly to the first embodiment.

Next, the procedure for assigning priority rankings to and print processing bitmap data stored in the high-capacity storage device according to the second embodiment will be described with reference to FIG. 11 and FIG. 12.

(S40) The control section 21-4 periodically monitors the common job information table 22-1 and determines whether the number of jobs J is any value other than ‘0’ due to reception of job data.

(S41) The control section 21-4 starts print processing when the number of jobs J is greater than ‘0’, in other words, when the number of jobs J has been changed to 1 or more. The control section 21-4 also determines whether the number of jobs J is J=1 or whether J>1, and it changes the processing method according to this result. More specifically, processing is differentiated according to whether or not there already exists bitmap data for another job in the high-capacity storage device 23 when job data is received. The merits of differentiating processing in this way are the same as those in the first embodiment described above.

(S42) If the number of jobs J>1, then the control section 21-4 judges that there is a plurality of job data present in the high-capacity storage device 23 and it implements priority ranking assignment for the print jobs. This priority ranking assignment function during print processing is the processing focused upon here.

In other words, priority rankings are assigned to the plurality of jobs stored in the high-capacity storage device 23. Since there exist job management information tables 22-2 which correspond in number to the value of the number of jobs J in the common job information table 22-1, the control section 21-4 reads out the total number of pages P and the number of pages printed Pe in the existing job management information tables 22-2 (this being restricted to tables having a reception flag Jf set to OFF), and it compares the value of (P−Pe) for each job and assigns a highest priority ranking to the job of which the value is smallest. As described above, any job which is being received (a job having Jf set to ON) is excluded from this comparison of the total number of remaining pages (P−Pe).

(S43) Next, the control section 21-4 determines whether the priority ranking indication flag Prf in the job management information table 22-2 is ON. In other words, it determines whether or not to decide the priority ranking of the job after each N pages have been printed.

(S44) If the indication flag Prf is not ON, then the priority ranking is not decided each time N pages are printed, and hence, similarly to the first embodiment, the job data for the selected job is read out, page by page, from the high-capacity storage device 23, and sent, together with its job number and header information, to the mechanical controller 24. The control section 21-4 increments the number of pages printed Pe in the job management information table 22-2 for that job by ‘1’, each time the data for one page has been transmitted.

(S45) The control section 21-4 then determines whether the number of pages printed Pe in the job management information table 22-2 has reached the total number of pages P. If the number of pages printed Pe has not yet reached the total number of pages P, then it returns to step S44.

(S46) On the other hand, if P=Pe, in other words, if all of the data for the job has been printed, then the number of jobs J in the common job information table 22-1 is decremented by ‘1’ and the job management information table 22-2 corresponding to the completed job is deleted. Thereupon, the control section 21-4 returns to step S40.

(S47) If the indication flag Prf is ON, then the priority ranking is decided each time N pages have been printed. Firstly, similarly to the first embodiment, the job data for the selected job is read out, page by page, from the high-capacity storage device 23, and sent, together with its job number and header information, to the mechanical controller 24. The control section 21-4 increments the number of pages printed Pe in the job management information table 22-2 for that job by ‘1’, each time the data for one page is transmitted.

(S48) The control section 21-4 then determines whether or not the number of pages printed Pe in the job management information table 22-2 has reached the total number of pages P. If P=Pe, in other words, if printing of all data for the job has been completed, then the control section 21-4 advances to step S46, decrements the number of jobs J in the common job information table 22-1 by ‘1’, and deletes the job management information table 22-2 corresponding to the completed job. It then returns to step S40.

(S49) If the number of pages printed Pe has not reached the total number of pages P, then the control section 21-4 identifies whether the number of consecutively printed pages N in the job management information table 22-2 is ‘1’ or less. If N is greater than ‘1’, then processing of the set number of consecutively printed sheets is not yet completed, and N is updated to N−1; the control section 21-4 returns to step S47, and performs print processing for the next page of that job. If, on the other hand, N is ‘1’ or less, then processing of the set number of consecutively printed sheets has been completed, and hence the control section 21-4 returns to step S42 in order to decide the priority ranking of the job. In the program, a state of N=1 defines the end of the consecutively printed sheets.

(S51) At step S41, if the number of jobs J is J=1, then job data for a plurality of jobs is not present in the high-capacity storage device 23. Consequently, the job data for one page is stored in the high-capacity storage device 23, and when the total number of pages P in the job management information table 22-2 becomes greater than ‘0’, print processing is started.

In other words, the control section 21-4 determines whether or not the total number of pages P is ‘0’, and if the total number of pages P is ‘0’, then it investigates whether the print data reception flag Jf in the job management information table 22-2 is ON. If the flag Jf is ON, then this indicates that data is being received, and hence the control section 21-4 waits until the total number of pages P changes to ‘1’ (until bitmap data for one page has been stored in the storage device 23). Conversely, if the flag Jf is OFF, then this indicates that data is not being received, and hence the number of jobs J in the common job information table 22−1 is decremented by ‘1’, and the job management information table 22-2 corresponding to the job is deleted. Thereupon, it returns to step S40.

(S52) If the total number of pages P in the job management information table 22-2 is not ‘0’, then the job data (bitmap data) for one page stored in the high-capacity storage device 23 is read out and sent to the mechanical controller 24. When transmission of this one page of data has been completed, the number of pages printed Pe in the job management information table 22-2 is incremented by ‘1’.

(S53) The control section 21-4 then judges whether the number of pages printed Pe in the job management information table 22-2 has reached the total number of pages P. If the number of pages printed Pe has not reached the total number of pages P, then it returns to step S57.

(S54) On the other hand, if P=Pe, in other words, if all of the stored data for the job has been printed, then it is investigated whether or not the data reception flag in the job management information table 22-2 is set to ON.

(S55) If the data reception flag Jf is ON, then data is being received and the control section 21-4 waits until job data has been stored in the high-capacity storage device 23. More specifically, the control section 21-4 judges whether or not the total number of pages P in the job management information table 22-2 exceeds the number of pages printed Pe, and if the total number of pages P does not exceed the number of pages printed Pe, then it determines that the data being received (in other words, the data being converted) has not yet reached the amount of data for one page, and it returns to step S54. If, on the other hand, the total number of pages P has exceeded the number of pages printed Pe, then the data being received has reached the amount of data for one page, and the control section 21-4 advances to step S57.

(S56) If the data reception flag Jf is not ON at step S54, then no data is being received, and hence that job is judged to be completed, the number of jobs J in the common job information table 22-1 is decremented by ‘1’, and the job management information table 22-2 corresponding to the completed job is deleted. Thereupon, the control section 21-4 returns to step S40.

(S57) Next, the control section 21-4 determines whether the priority ranking indication flag Prf in the job management information table 22-2 is ON. In other words, it determines whether or not the priority ranking is to be decided each time N pages have been printed. If the indication flag Prf is not ON, then the priority ranking is not decided each time N pages are printed, and the procedure advances to step S52, similarly to the first embodiment. In other words, job data for the selected job is read out, page by page, from the high-capacity storage device 23 and sent to the mechanical controller 24.

(S58) If the indication flag Prf is set to ON, then the priority ranking is decided each time N pages have been printed. The control section 21-4 judges whether the number of consecutively printed pages N in the job management information table 22-2 is set to ‘1’ or less. If N is greater than ‘1’, then processing for the set number of consecutively printed pages has not yet completed, and hence N is updated to ‘N−1’, and the procedure returns to step S52 in order to perform print processing of the next page of the job. If, on the other hand, N is ‘1’ or less, then processing for the set number of consecutively printed pages has completed, and hence the procedure returns to step S40 in order to decide the priority ranking.

In this way, according to the present invention, the printer device performs storage processing, and print processing for received print data, in a parallel and asynchronous fashion. Therefore, when a plurality of jobs are received, (if J>1), then efficient print processing can be achieved whereby print processing is performed starting from a job for which bitmap development is completed, whilst a job being received is restricted to bitmap development only.

Moreover, according to the second embodiment of the present invention, rather than simply assigning priority rankings for print processing to each job, the priority ranking for a job being printed is revised with regard to the number of remaining pages, each time a number of pages corresponding to a value N (number of pages to be printed consecutively) previously set via the operating panel of the printer device, or the like, has been printed.

Therefore, when bitmap development of a one-page print job is completed whilst a large volume of job data (bitmap converted data) is being printed, then it is possible to interpose the printing of the one-page job even while the printing of a large-volume job is underway.

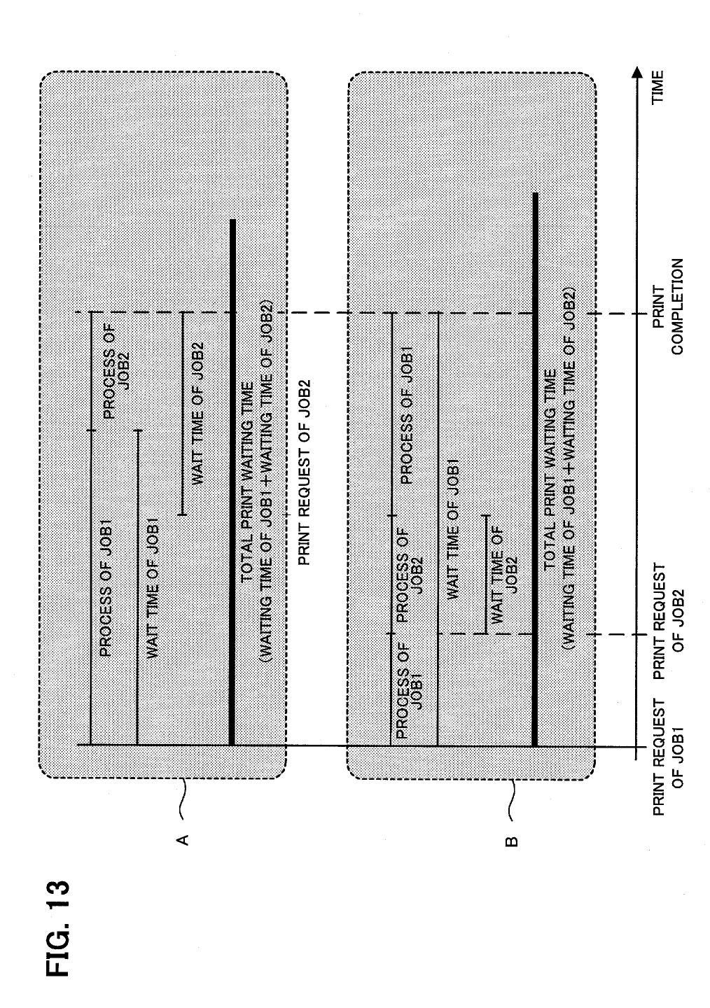

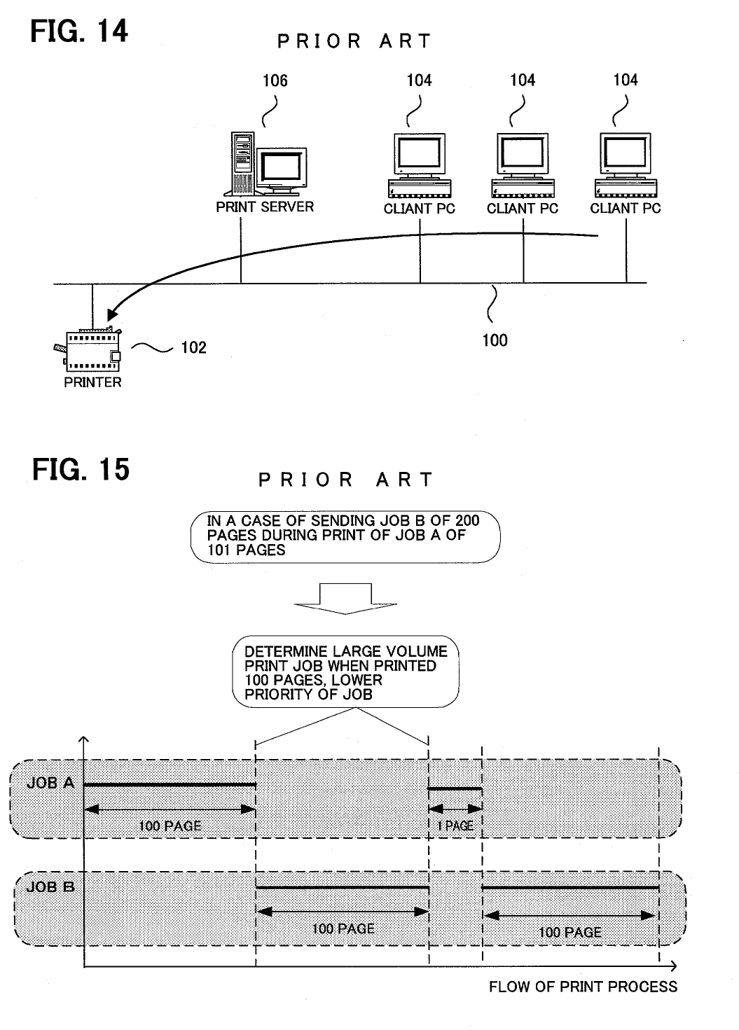

Moreover, as illustrated in FIG. 13, when print processing for job 2 arises during print processing of large-volume job data for job 1, the remaining number of pages after bitmap development is compared, and when the remaining number of pages for job 1 is less than the number of print pages for job 2, as shown by ‘A’ in FIG. 13, then print processing for job 1 is continued, and printing of job 2 is performed when print processing of job 1 has been completed, whereas if the remaining number of pages for job 1 is greater than the number of print pages for job 2, as shown by ‘B’ in FIG. 13, then the print processing of job 1 is interrupted and printing of job 2 is prioritised, whereupon printing of job 1 is resumed.

Therefore, it is possible to shorten the overall waiting time in all cases. Using the Prf flag in the job management information table, it is possible to select between executing a priority ranking revision function according to the number of consecutively printed pages (Prf=ON), and determining priority rankings in job units (Prf=OFF).

The indication flag Prf is set on the operating panel of the printer device, and it may be changed according to the user's requirements, and the functional level of the stacker processing section installed in the printer device. For example, when the printer 2 is equipped with a multi-bin stacker 3, as in the cases illustrated in FIG. 1 to FIG. 3, then an accommodating shelf can be set for each job unit, and even if a job being printed is interrupted in order to print a different job, the printed pages can be sorted readily and hence there is a significant advantage in using the device with Prf=ON.

However, in the case of a printer device 2 that is not equipped with a multi-bin stacker 3, it is often more convenient to receive printed pages for each job independently, and hence Prf is set to OFF and processing in job units is implemented. Moreover, the number of consecutively printed pages may also be set according to the use environment, in order to suit the user.

### Other Embodiments

The foregoing description related to an electro-photographic printer forming a page printer which converts print data to bitmap data in page units and executes printing in page units, but the present invention may also be applied to printers based on other printing methods. Moreover, here, a multi-bin stacker was used in order to sort sheets for different jobs, but other sorting methods may also be used, for instance, inserting a banner sheet (dividing sheet) between the pages of different jobs. A storage device other than a hard disk drive may be used for the high-capacity storage device, provided that it has a large storage capacity.

As described above, according to the present invention, the following merits are obtained.

Since printing competition is judged at the printer, and priority rankings are determined after bitmap conversion for jobs that have been converted to bitmap data, it is possible to determine priority rankings for a printing operation time period defined by a number of printed pages, and accurate priority rankings which enable shortening of the overall print waiting time can be determined.

Moreover, since the printer executes job data storage processing and print processing in parallel fashion, this determination of priority rankings can be achieved in a simple manner.

What is claimed is:

1. A job processing method for a printer that receives print jobs and performs printing operations corresponding to the print jobs, comprising:
a storing step of converting said received print jobs to bitmap data and storing said bitmap data with job units in a storage device; and
a print processing step of reading out said stored bitmap data and performing print operations in page units;
wherein said print processing step comprises:
a step of comparing the numbers of print pages of a plurality of jobs for which said bitmap data has been stored, and determining priority rankings for said jobs that are to be printed; and
a step for reading out said bitmap data of a job selected by the determination of said priority rankings, and performing print operations in page units.

2. The job processing method for a printer according to claim 1, wherein said print processing step further comprises a step of detecting that the number of printed pages for one job has reached a prescribed number of pages due to said printing operation, and executing determination of said priority rankings.

3. The job processing method for a printer according to claim 1, wherein said storing step is executed in units of said received jobs, and said step of determining priority rankings is executed when said bitmap data for said plurality of jobs has been stored in said storage device.

4. The job processing method for a printer according to claim 3, wherein said print processing step further comprises a step of executing said printing operation each time said bitmap data for one page is stored, when said bitmap data for a plurality of jobs is not stored in said storage device.

5. The job processing method for a printer according to claim 1, further comprising:
a step of updating a number of jobs each time said job is received; and
a step of determining whether or not to implement said priority ranking determination step by referring to said number of jobs.

6. The job processing method for a printer according to claim 2, further comprising a step of controlling execution of said priority ranking determination step by referring to a flag indicating whether or not to execute said priority ranking determination step each time said prescribed number of pages has been printed consecutively.

7. A printer for receiving print jobs and performing printing operations corresponding to the print jobs, comprising:
a storage unit for storing job data converted to bitmap data; and
a control unit for implementing storage processing for converting said received print jobs to bitmap data and for storing said bitmap data with units of jobs in said storage unit, and print processing for reading out said stored bitmap data and executing printing operations in page units;
wherein said control unit compares the numbers of print pages for a plurality of jobs for which said bitmap data has been stored, determines priority rankings for said jobs that are to be printed, reads out said bitmap data of a job selected by the determination of said priority rankings, and executes print operations in page units.

8. The printer according to claim 7, wherein said control unit detects that the number of printed pages for one job has reached a prescribed number of pages due to said printing operation, and executes determination of said priority rankings according to said detection.

9. The printer according to claim 7, wherein said control unit executes in units of said received jobs, and executes when said bitmap data for said plurality of jobs has been stored in said storage device.

10. The printer according to claim 9, wherein said control unit executes said printing operation each time said bitmap data for one page is stored, when said bitmap data for a plurality of jobs is not stored in said storage device.

11. The printer according to claim 7, wherein said control unit updates a number of jobs each time said job is received, and determines whether or not to implement said priority ranking determination by referring to said number of jobs.

12. The printer according to claim 8, wherein said control unit controls execution of said priority ranking determination by referring to a flag indicating whether or not to execute said priority ranking determination each time said prescribed number of pages has been printed consecutively.

13. A printer system comprising:
a printer for receiving print jobs and performing printing operations corresponding to the print jobs; and
a plurality of clients issuing said print jobs to said printer via a network;
wherein said printer comprises:
a storage unit for storing job data converted to bitmap data; and
a control unit for converting said received print jobs to bitmap data, storing said bitmap data with units of said jobs in said storage unit, reading out said stored bitmap data and executing printing operations in page units; and
wherein said control unit compares the numbers of print pages for a plurality of jobs for which said bitmap data has been stored, determines priority rankings for said jobs that are to be printed, reads out said bitmap data of a job selected by the determination of said priority rankings, and performs print operations in page units.

14. The printer system according to claim 13, wherein said control unit detects that the number of printed pages for one job has reached a prescribed number of pages due to said printing operation, and executes determination of said priority rankings according to said detection.

15. The printer system according to claim 13, wherein said control unit executes in units of said received jobs, and executes when said bitmap data for said plurality of jobs has been stored in said storage device.

16. The printer system according to claim 15, wherein said control unit executes said printing operation each time said bitmap data for one page is stored, when said bitmap data for a plurality of jobs is not stored in said storage unit.

17. The printer system according to claim 13, wherein said control unit updates a number of jobs each time said job is received, and determines whether or not to implement said priority ranking determination by referring to said number of jobs.

18. The printer system according to claim 14, wherein said control unit controls execution of said priority ranking determination by referring to a flag indicating whether or not to execute said priority ranking determination each time said prescribed number of pages has been printed consecutively.

19. A program for causing a printer to execute printing operations corresponding to received print jobs and stored:
program data for performing a storing step of converting said received print jobs to bitmap data and storing said bitmap data with units of said jobs in a storage device; and
program data for comparing the numbers of print pages of a plurality of jobs for which said bitmap data has been stored, determining the priority rankings of said jobs that are to be printed, reading out said bitmap data for a job selected by the determination of said priority rankings, and executing printing operations in page units.
